(19) United States
(12) Patent Application Publication
(10) Pub. No.: US 2004/0040575 A1
(43) Pub. Date: Mar. 4, 2004

(54) Brush for cleaning/scrubbing a substrate

(76) Inventors: Alexander Tregub II, Oak Park, CA (US); Jamie Ludke, Hillsboro, OR (US); Mark P. McGhee, Hillsboro, OR (US); Mansour Moinpour, San Jose, CA (US); Joseph W. Parks JR., Beaverton, OR (US); Jade Sun, Tempe, AZ (US); Jonathan W. Thibado, Beaverton, OR (US)

Correspondence Address: Pillsbury Winthrop LLP, Intellectual Property group, 725 S. Figueroa Street, Suite 2800, Los Angeles, CA, 90017-5406, US

(21) Appl. No.: 10/229,556

(22) Filed: Aug. 28, 2002

(51) Int. Cl. B08B 1/04

(52) U.S. Cl. 134/6; 15/77; 15/88.3; 15/102

(57) ABSTRACT

A brush assembly includes a first brush having a central portion and end portions. The central portion is recessed from the end portions. A second brush is provided having an outer surface and opposed to the first brush. The first brush and the second brush are adapted to receive a planar object therebetween. The outer surface and the end portions are in contact with the planar object and the central portion avoids contact with the planar object.

### BACKGROUND

1. Technical Field

An embodiment of the present invention relates to a brush for cleaning and scrubbing a substrate. More particularly, an embodiment of the present invention relates to a brush for cleaning and scrubbing a planar object such as a silicon wafer or semiconductor substrate.

2. Discussion of the Related Art

In the manufacture of integrated circuits (ICs), semiconductor wafer surface planarity is of utmost importance. To achieve the degree of planarity necessary to produce ultra-high density ICs, chemical-mechanical polishing/planarization (CMP) is often utilized. Generally, CMP involves holding a semiconductor wafer against a moving polishing surface that is wetted with a chemically-reactive slurry, which contains abrasive materials such as silica or alumina. The polishing surface is usually a planar pad made of relatively soft, porous material, such as brown polyurethane, and it is usually mounted on a planar platen. A major concern with the use of CMP is the efficient and complete removal of the polishing slurry to prevent problems in subsequent processing steps.

After CMP, a wafer rinse and some form of mechanical agitation of the wafer surface is usually employed to remove the slurry chemical and abrasive residue from the surface of the semiconductor wafer. Particle removal is greatly enhanced by the addition of mechanical shear forces. Accordingly, mechanical brush scrubbing is widely used as a method of post-CMP cleaning.

Typically, to scrub and clean a semiconductor wafer, a pair of brush rollers is utilized. Each brush is pressed against, respectively, the front and back surfaces of the semiconductor wafer. The purpose of the brushes being pressed against each surface is two-fold: to clean the wafer surfaces, and to support the semiconductor wafer to uniformly distribute the pressure placed onto the wafer during its scrubbing and cleaning.

In some instances, the semiconductor wafer, or other substrate, need be cleaned only on one side. In this particular case, contact between the brush and the other side of the wafer or substrate, which requires no cleaning, can be detrimental. Such a contact may cause contamination of the wafer or substrate surface with particles, scratch the surface, etc. In other words, conventional cleaning brushes do not allow for the elimination or reduction of the contact and contact area between the brush and the wafer/substrate surface while still providing brush support of the wafer/substrate during scrubbing and cleaning.

### BRIEF DESCRIPTION OF THE DRAWINGS

FIG. 1 illustrates a perspective view of a brush apparatus having a first brush and a second brush according to an embodiment of the present invention;

FIG. 2 illustrates a side view of a brush according to an embodiment of the present invention;

FIG. 3 illustrates a side view of a brush according to an embodiment of the present invention;

FIG. 4 illustrates a side view of a brush according to an embodiment of the present invention;

FIG. 5 illustrates a side view of a brush according to an embodiment of the present invention; and

FIG. 6 illustrates a flow chart diagram of scrubbing/cleaning a planar object utilizing a first brush and a second brush according to an embodiment of the present invention.

### DETAILED DESCRIPTION

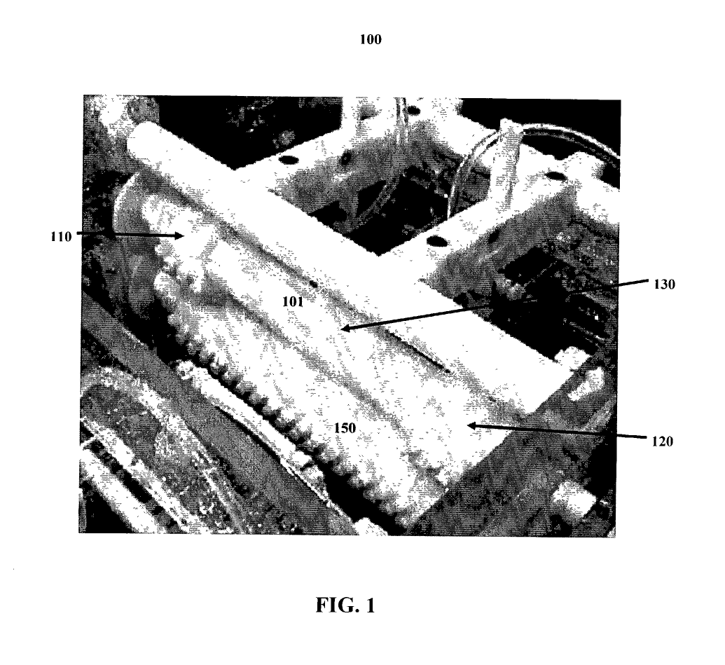

FIG. 1 illustrates a perspective view of a brush apparatus having a first brush and a second brush according to an embodiment of the present invention. In the embodiment illustrated in FIG. 1, the first brush 101 of the brush apparatus 100 is in a top position while the second brush 150 of the brush apparatus 100 is in a bottom position. However, the brushes 101, 150 may be configured in a reverse orientation where the first brush 101 is in the bottom position and the second brush 150 is in the top position. In the configuration illustrated in FIG. 1, the brush apparatus 100 is adapted to scrub/clean the bottom surface of a wafer or substrate. A motor is provided with the brush apparatus 100 to drive and rotate at least one of the brushes 101, 150.

The first brush 101 has a central portion 130 and end portions 110, 120. The central portion 130 is recessed from the end portions 110, 120. The second brush 150 has an outer surface and opposes the first brush 101. The outer surface of the second brush 150 may be the same as the outer surfaces of the end portions 110, 120 of the first brush 101, or they may be different. The first brush 101 and the second brush 150 are adapted to receive a planar object, such as a semiconductor wafer or substrate in between the first brush 101 and the second brush 150. Due to the design of the first brush 101, the outer surface of the second brush 150 and the end portions 110, 120 of the first brush 101 are in contact with the planar object when inserted in between the first brush 101 and the second brush 150. Because of the recess within the central portion 130 of the first brush 101, the central portion 130 avoids contact with the planar object as it is inserted in between the first brush 101 and the second brush 150. Therefore, contact by the brush apparatus 100 of the top surface of a planar object to be scrubbed/cleaned is greatly minimized by utilizing the first brush 101 according to an embodiment of the present invention, and contamination and damage to the planar object during scrubbing/cleaning is also minimized.

In several steps of IC manufacturing, backside scrubbing of the wafer is utilized to remove and/or reduce the particles left on the backside of the wafer during IC manufacturing. Particles left on the wafer backside can distort subsequent lithographic processing. Flatness of the wafer (i.e., no particles on the backside) is extremely important in producing optimal focus for modern optical lithography employing wavelengths of 248 nanometers (nm) and less. The aim of backside scrubbing is to remove particles from only the backside of the wafer; however, a brush pair that is utilized in a conventional brush apparatus and in a scrubber is in contact with both back (bottom) and front (top) surfaces of the wafer. Contact from both sides of a wafer is required to provide the mechanical support and correct pressure on the wafer. However, while polishing of the back side of the wafer is beneficial, as it removes the particles from this side, the polishing of the front side can be detrimental because it tends to distribute the particles from the edges of the wafer over the entire surface of the front side of the wafer, which may cause defects in the wafer. By reducing the contact and contact area between the first brush 101 and the front side (top surface) of the planar object, contamination and distribution of particles from the edges of the wafer are greatly reduced.

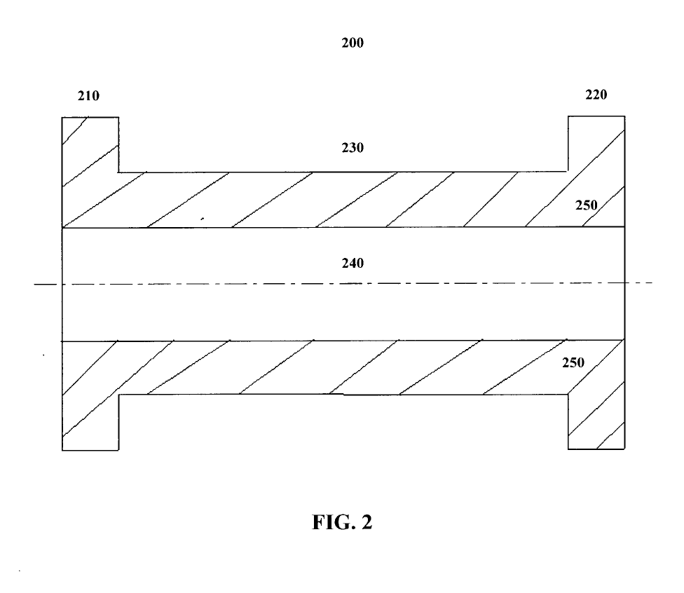

FIG. 2 illustrates a side view of a brush according to an embodiment of the present invention. The brush 200 according to an embodiment of the present invention may be “dog bone” shaped or “dumb bell” shaped so that there are end portions 210, 220 and a central portion 230 that is recessed from the end portions 210, 220. Although the “dog bone” or “dumb bell” shape is illustrated, any suitable configuration of a brush having a central portion 230 that is recessed from the end portions 210, 220 may be utilized. This configuration of the brush 200 reduces the contact area between the brush 200 and a planar object to be scrubbed/cleaned, such as a polished substrate or a silicon wafer, so as to preserve one side of the wafer from particle deposit contamination and scratching, while maintaining the efficiency of the backside scrubbing/cleaning of the substrate. The end portions 210, 220 provide support to the planar object, while the central portion 230 is not in contact with the planar object. The brush 200 illustrated in FIG. 2 is a “sharp” dog bone shape design, that is, the central portion 230 is cut away with a rectangular recess.

The brush 200 may be formed of an outer material 250 and a central core 240 onto which the outer material 250 is coupled. In the brush 200 illustrated in FIG. 2, the recess is cut away from the central portion 230 of the outer material 250 of the brush 200. The brush 200 may be formed by utilizing a conventional cylindrical brush, or the like, such as the one utilized as the second brush 150 illustrated in FIG. 1. Because the brush 200 may be formed utilizing the same brush type as that of the second brush 150, the outer surface of the end portions 210, 220 of the brush 200 may be the same as the outer surface of the second brush 150. For example, the outer surface of the end portions 210, 220 of the brush 200 may be smooth, noduled (see FIG. 1), splined, or dented (or Swiss cheese-like). The noduled, splined, or dented outer surfaces further reduce the contact area between the brush and the surface of the planar object compared to a conventional smooth cylindrical brush, where the entire brush surface is in contact with the surface of the planar object. Conversely, the bottom brush 150 may have the same or different type of outer surface as that of the top brush 101. However, because the central portion 230 of the brush 200 is recessed and does not make contact with the planar object to be scrubbed/cleaned, the type of surface (e.g., brush-type surface, smooth core surface, etc.) utilized for the central portion 230 is not critical.

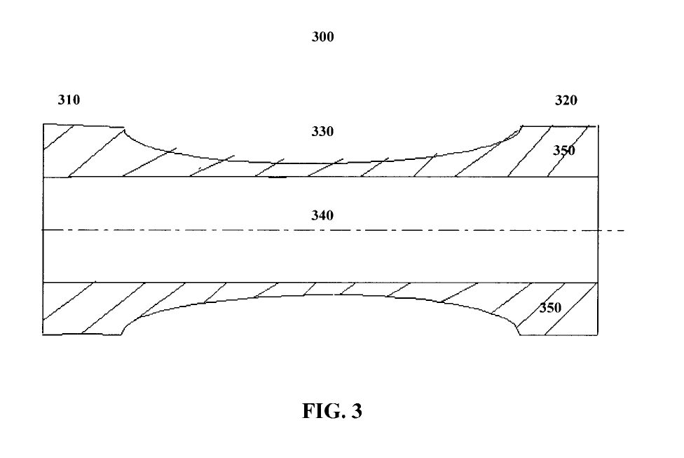

FIG. 3 illustrates a side view of a brush according to an embodiment of the present invention. Similar to the brush 200 in FIG. 2, the brush 300 illustrated in FIG. 3 includes end portions 310, 320 and a central portion 330 having a curved recess (i.e., “curved” dog bone shaped). The brush 300 may be formed of an outer material 350 and a central core 340 onto which the outer material 350 is coupled. This configuration of the brush 300 also reduces the contact area between the brush 200 and a planar object. The end portions 310, 320 provide support to the planar object, while the central portion 330 is not in contact with the planar object.

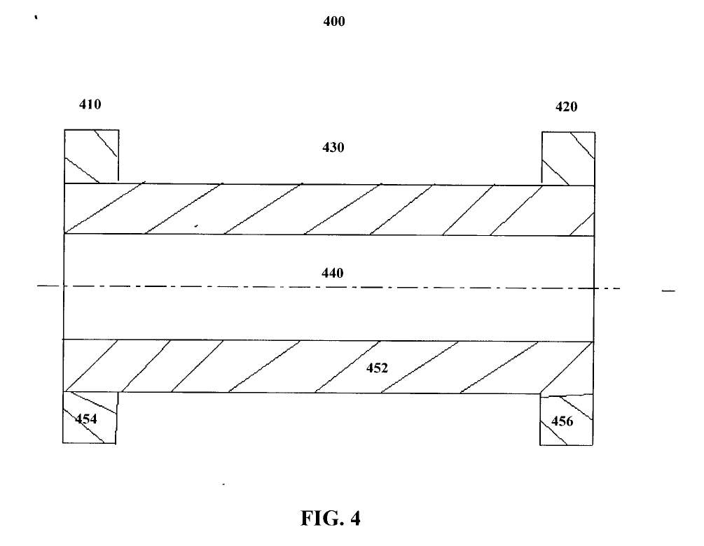

FIG. 4 illustrates a side view of a brush according to an embodiment of the present invention. The brush 400 illustrated in FIG. 4 is similar to the “sharp” dog bone shaped brush illustrated in FIG. 2. The brush 400 includes end portions 410, 420 and a central portion 430 having a rectangular recess. The brush 400 is assembled from a brush core 440, an intermediate outer material 452 coupled to the core 440, and an exterior outer material 454, 456 coupled to the intermediate outer material 452 forming the end portions 410, 420. The end portions 410, 420 provide support to a planar object, while the central portion 430 is not in contact with the planar object. Although these particular components are utilized to form the brush 400 in FIG. 4, any suitable combination and number of pieces, components, or parts may be utilized to construct the brushes according to embodiments of the present invention.

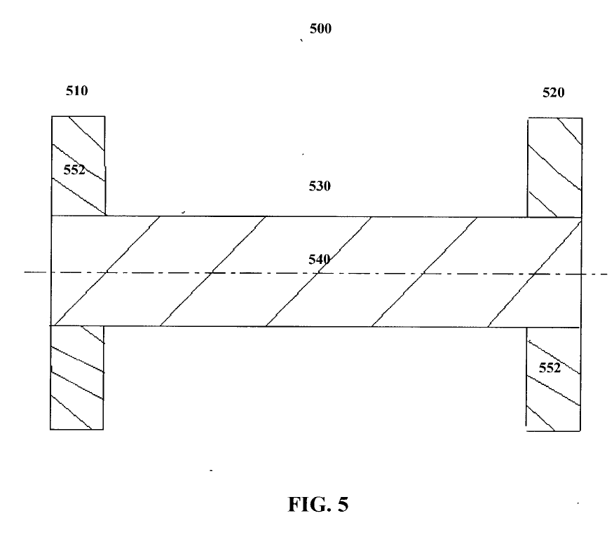

FIG. 5 illustrates a side view of a brush according to an embodiment of the present invention. The brush 500 illustrated in FIG. 5 is similar to the “sharp” dog bone shaped brushes illustrated in FIGS. 2 and 4. The brush 500 includes end portions 510, 520 and a central portion 530 having a rectangular recess. The brush 500 may be assembled from a brush core 540 and an outer material 552 coupled to the core 540 forming the end portions 510, 520. The core 540 of the brush 500 in FIG. 5 serves as the outer surface within the recess of the central portion 530 of the brush 500. The end portions 510, 520 provide support to a planar object, while the central portion 530 is not in contact with the planar object. Although these particular components are utilized to form the brush 500 in FIG. 5, any suitable combination and number of pieces, components, or parts may be utilized to construct the brushes according to embodiments of the present invention.

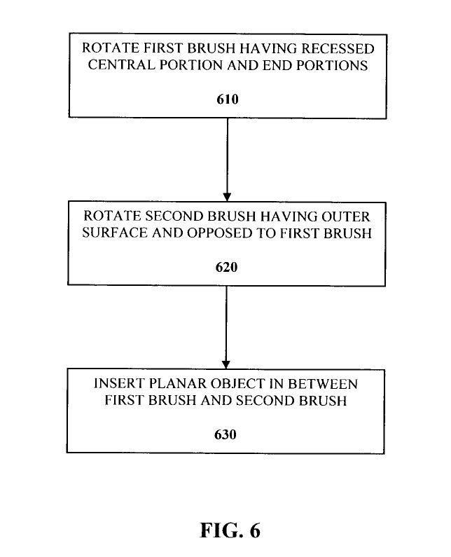

FIG. 6 illustrates a flow chart diagram of scrubbing/cleaning a planar object utilizing a first brush and a second brush according to an embodiment of the present invention. With reference to FIG. 1, a first brush 101 is rotated 610. The first brush 101 has a central portion 130 and end portions 110, 120. The central portion 130 of the first brush 101 is recessed from the end portions 110, 120 A second brush 150 is also rotated 620. The second brush 150 has an outer surface and is opposed to the first brush 101. The first brush 101 and the second brush 150 are adapted to receive a planar object therebetween. With the first brush 101 and the second brush 150 rotating, the planar object to be scrubbed/cleaned, such as a semiconductor wafer or substrate, is inserted in between the first brush 101 and the second brush 150. The outer surface of the second brush 150 and the end portions 110, 120 of the first brush 101 make contact with the planar object as it is inserted in between the two brushes 101, 150, and the central portion 130 of the first brush 101 avoids contact with the top surface of the planar object. The brush apparatus 100, for example, as illustrated in FIG. 1 permits the elimination or reduction of the contact (and contact area) between the first brush 101 and the top surface of a planar object (the top surface of which does not require to be scrubbed/cleaned) while still providing mechanical (brush) support of the planar object and uniform pressure distribution as it goes through the brushes 101, 150 during the scrubbing and cleaning operation of the bottom surface of the planar object. Therefore, contact with the top surface of the planar object is minimized (to the sides only by the end portions 110, 120 of the first brush 101), therefore minimizing contamination as a result of contact with a brush.

The methods and apparatuses according to embodiments of the present invention may be utilized for backside (or one-side) scrubbing of bare wafers or wafers coated with poly-silicon, deposited silicon nitride, and deposited oxides (e.g., standard oxides plus Low k (dielectric constant) dielectrics), as well as utilized prior to lithography steps involving implanted layers including wells, tips, and source/drains. The applications of the methods and apparatuses of embodiments of the present invention are not limited only to those described herein and any other suitable applications may be utilized.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A brush assembly, comprising:
a first brush having a central portion and end portions, wherein the central portion is recessed from the end portions; and
a second brush having an outer surface and opposed to the first brush, wherein the first brush and the second brush are adapted to receive a planar object therebetween, and the outer surface and the end portions are in contact with the planar object and the central portion avoids contact with the planar object.

2. The brush assembly according to claim 1, wherein the brush assembly forms a post chemical-mechanical planarization (CMP) brush assembly.

3. The brush assembly according to claim 1, wherein the planar object is a silicon wafer.

4. The brush assembly according to claim 1, wherein the planar object is a semiconductor substrate.

5. The brush assembly according to claim 1, wherein the first brush has a cylindrical core.

6. The brush assembly according to claim 1, wherein the recess is rectangular.

7. The brush assembly according to claim 1, wherein the recess is curved.

8. The brush assembly according to claim 1, wherein outer surfaces of the end portions of the first brush have a plurality of nodules.

9. The brush assembly according to claim 1, wherein outer surfaces of the end portions of the first brush have a plurality of splines.

10. The brush assembly according to claim 1, wherein outer surfaces of the end portions of the first brush have a plurality of dents.

11. A method of cleaning a planar object, comprising:
rotating a first brush having a central portion and end portions, wherein the central portion is recessed from the end portions;
rotating a second brush having an outer surface and opposed to the first brush, wherein the first brush and the second brush are adapted to receive a planar object therebetween; and
inserting the planar object in between the first brush and the second brush, wherein the outer surface and the end portions are in contact with the planar object and the central portion avoids contact with the planar object.

12. The method according to claim 11, wherein the first brush and the second brush form a post chemical-mechanical planarization (CMP) brush assembly.

13. The method according to claim 11, wherein the planar object is a silicon wafer.

14. The method according to claim 11, wherein the planar object is a semiconductor substrate.

15. The method according to claim 11, wherein the first brush has a cylindrical core.

16. The method according to claim 11, wherein the recess is rectangular.

17. The method according to claim 11, wherein the recess is curved.

18. The method according to claim 11, wherein outer surfaces of the end portions of the first brush have a plurality of nodules.

19. The method according to claim 11, wherein outer surfaces of the end portions of the first brush have a plurality of splines.

20. The method according to claim 11, wherein outer surfaces of the end portions of the first brush have a plurality of dents.

21. A brush apparatus, comprising:
a first brush having a central portion and end portions, wherein the central portion is recessed from the end portions;
a second brush having an outer surface and opposed to the first brush, wherein the first brush and the second brush are adapted to receive a planar object therebetween, and the outer surface and the end portions are in contact with the planar object and the central portion avoids contact with the planar object; and
a motor coupled to at least one of the first brush and the second brush to rotate at least one of the first brush and the second brush.

22. The brush apparatus according to claim 21, wherein the brush apparatus is a post chemical-mechanical planarization (CMP) brush apparatus.

23. The brush apparatus according to claim 21, wherein the planar object is a silicon wafer.

24. The brush apparatus according to claim 21, wherein the planar object is a semiconductor substrate.

25. The brush apparatus according to claim 21, wherein the first brush has a cylindrical core.

26. The brush apparatus according to claim 2 1, wherein the recess is rectangular.

27. The brush apparatus according to claim 21, wherein the recess is curved.

28. The brush apparatus according to claim 21, wherein outer surfaces of the end portions of the first brush have a plurality of nodules.

29. The brush apparatus according to claim 21, wherein outer surfaces of the end portions of the first brush have a plurality of splines.

30. The brush apparatus according to claim 21, wherein outer surfaces of the end portions of the first brush have a plurality of dents.
